(19) United States
(12) Patent Application Publication
(10) Pub. No.: US 2026/0220472 A1
(43) Pub. Date: Jul. 30, 2026

(54) TAGGING METHOD AND SYSTEM FOR MACHINE LEARNING PURPOSES

(71) Applicant: Eye-Net Mobile Ltd., Ness Ziona (IL)

(72) Inventors: Dror ELBAZ, Rishon Lezion (IL); Tal LAVI, Modi’in (IL)

(73) Assignee: Eye-Net Mobile Ltd., Ness Ziona (IL)

(21) Appl. No.: 19/144,989

(22) PCT Filed: Jan. 1, 2024
(86) PCT No.: PCT/IL2024/050003

§ 371 Date: Jul. 1, 2025

Related U.S. Application Data
(60) Provisional application No. 63/436,609, filed on Jan. 1, 2023.

(51) Int. Cl. G06N 3/0895

(52) U.S. Cl. CPC G06N 3/0895

(57) ABSTRACT

The present invention relates generally to systems and methods of tagging (annotating) data for further use in supervised or semi-supervised machine learning. More specifically, the present invention relates to facilitating the tagging of data, in which the object of tagging is not presented in a detailed way. The invention represents a technical solution which provides effective detection and correction of incorrectly tagged data and helps tagging specialists to reduce the number of tagging mistakes. The invention represents method of facilitating data tagging for machine learning purposes and thereby increases training dataset quality and, consequently, increases reliability of ML model prediction or classification outputs.

### CROSS-REFERENCE TO RELATED APPLICATIONS

This application claims the benefit of priority of U.S. patent application Ser. No. 63/436,609 filed 1 Jan. 2023, and titled: “TAGGING METHOD FOR MACHINE LEARNING PURPOSES”, which is hereby incorporated by reference in its entirety.

### FIELD OF THE INVENTION

The present invention relates generally to systems and methods of tagging (annotating) data for further use in supervised or semi-supervised machine learning. More specifically, the present invention relates to facilitating the tagging of data, in which the object of tagging is not presented in a detailed way.

### BACKGROUND OF THE INVENTION

As it is known, development of mathematical models that can learn from, and make predictions on data is a general purpose of machine learning. In particular, supervised and semi-supervised machine-learning includes model training using so-called “training dataset” (or “supervisory dataset”), fine-tuning using “validation dataset” and testing using “test dataset”. The term “training dataset” is commonly referred to a set of examples-pairs of input and output vectors (or scalars). The model iteratively analyzes an input data of a training dataset to produce a result, which is then compared with a target result-corresponding output data for each input data in the training dataset. Based on the comparison, a supervised learning algorithm determines the optimal combinations of variables that will provide the highest prediction reliability. In the end, well-trained model must show sufficiently reliable results when analyzing unknown data.

Consequently, quality of a training dataset is reasonably considered a crucial aspect of machine learning. However, in practice, the work involved in acquiring, tagging (labeling), and preparing training datasets turns out to be cumbersome and expensive. This work requires intricate coordination between and combination of machine-learning processes, human resources, and tagging tools. The process of training dataset creation becomes even more challenging when the task is directed to analysis of obscure data which is hard to classify and tag carefully even for human, not to mention the ML model that is to be trained to do that.

In particular, certain problems may occur when tagging different kinds of geographical data. For example, the task of tagging multi-level causeways (multi-level transportation routes, e.g., pedestrian and automobile bridges, interchanges etc.) on satellite images and classifying them by type in order to create a ML model for controlling autonomous uncrewed automobile could be considered a task of such a type. Since, on the satellite images, causeways are viewed from above, it is hard to reliably distinguish between multi-level and single-level ones.

Nevertheless, a well-trained ML model could potentially show more reliable results than a human observer, because it can reveal deeply concealed features of an input data, which turn out to be highly relevant to the target output data.

In addition to training dataset quality issues, there are quantity ones as well. In practice, it is extremely hard to define the amount of training data that is sufficient to achieve reliable training results. So, this aspect becomes essential, especially when it is considered together with the fact that preparing training dataset is cumbersome and expensive.

### SUMMARY OF THE INVENTION

Accordingly, there is a need for a technical solution which would provide effective detection and correction of incorrectly tagged data and would help tagging specialists to reduce the number of tagging mistakes in future. In other words, there is a need for a method of facilitating data tagging for machine learning purposes, thereby increasing training dataset quality and, consequently, increasing reliability of ML model prediction or classification outputs.

To overcome the abovementioned shortcomings of the prior art, the following invention is provided.

In general aspect, the invention may be directed to a method of creating, by at least one processor, a labeled dataset for training a machine-learning (ML) model, the method including receiving an annotation task representing a requirement for annotating an input data element; dividing the annotation task into a plurality of annotation sub-tasks, each representing a requirement for annotating a respective non-annotated portion of the input data element; assigning one or more annotation sub-tasks of the plurality of sub-tasks to one or more taggers; obtaining respective annotated portions of the input data element, based on a plurality of annotations provided by said taggers corresponding to the assigned annotation sub-tasks; and forming the labeled dataset by aggregating the annotated portions.

In another general aspect, the invention may be directed to a system for creating a labeled dataset, the system including a non-transitory memory device, wherein modules of instruction code are stored, and at least one processor associated with the memory device, and configured to execute the modules of instruction code, whereupon execution of said modules of instruction code, the at least one processor is configured to receive an annotation task representing a requirement for annotating an input data element; divide the annotation task into a plurality of annotation sub-tasks, each representing a requirement for annotating a respective non-annotated portion of the input data element; assign one or more annotation sub-tasks of the plurality of sub-tasks to one or more taggers; obtain respective annotated portions of the input data element based on a plurality of annotations, provided by said taggers corresponding to the assigned annotation sub-tasks; and form the labeled dataset by aggregating the annotated portions.

In yet another general aspect, the invention may be directed to a method of creating, by at least one processor, a labeled dataset for training a machine-learning (ML) model, the method including: receiving an annotation task representing a requirement for annotating an input data element; receiving the input data element; dividing the annotation task into a plurality of annotation sub-tasks, each representing a requirement for annotating a respective non-annotated portion of the input data element; performing an iterative process, wherein each iteration may include: inferring a pretrained ML-based model on one or more non-annotated portions of the input data element, to calculate a confidence value, representing confidence of pertinence of the one or more non-annotated portions of the input data element to the one or more predefined classes; assigning at least one annotation sub-task of the plurality of sub-tasks to at least one tagger, based on the calculated confidence value; obtaining respective annotated portions of the input data element, based on a plurality of annotations provided by said at least one tagger corresponding to the assigned at least one annotation sub-task; forming an interim version of the labeled dataset by aggregating the annotated portions; utilizing the interim version of the labeled dataset as supervisory data, to supplementary train the pretrained ML-based model so as to recalculate the confidence value.

In some embodiments, said assigning the one or more annotation sub-tasks and obtaining respective annotated portions are performed as an iterative process, including a sequence of at least two iterations.

In some embodiments, the sequence of at least two iterations further includes at least one initial iteration, further including forming an interim version of the labeled dataset by aggregating the annotated portions; and utilizing an interim version of the labeled dataset as supervisory data, to train the ML model so as to calculate a confidence value, representing confidence of pertinence of the one or more portions of the input data element to the one or more predefined classes; and at least one interim iteration, further including inferring the trained ML model on the one or more non-annotated portions of the input data element, to calculate respective confidence values; and assigning at least one annotation sub-task of the plurality of sub-tasks to one or more tagging modules, based on the calculated confidence value.

In some embodiments, the sequence of at least two iterations further includes at least one initial iteration, further including performing a multi-leveled quality assurance (QA) procedure on the plurality of annotations, to obtain a respective plurality of QA scores; and at least one interim iteration, further including assigning the one or more annotation sub-tasks of the plurality of sub-tasks to specific taggers, based on the QA score.

In some embodiments, the at least one initial iteration further includes forming an interim version of the labeled dataset by aggregating the annotated portions; and utilizing an interim version of the labeled dataset as supervisory data, to train the ML model so as to calculate a confidence value, representing confidence of pertinence of the one or more portions of the input data element to the one or more predefined classes; and at least one interim iteration further includes inferring the trained ML model on the one or more non-annotated portions of the input data element, to calculate respective confidence values; and performing the multi-leveled quality assurance (QA) procedure on the plurality of annotations, based on the calculated confidence value.

In some embodiments, the method further includes receiving at least one supplementary data element related to one or more portions of the input data element by at least one common characterizing feature; and performing the multi-leveled quality assurance (QA) procedure on the plurality of annotations, based on the at least one respective supplementary data element.

In some embodiments, performing a multi-levelled QA procedure includes for at least one annotation sub-task, receiving an annotation via a first user interface (UI), said first UI pertaining to a respective first-level tagger; receiving at least one supervisory feedback data element for the annotation via a second UI, pertaining to a second-level tagger; and calculating the QA score of the annotation based on the supervisory feedback data element.

In some embodiments, the method further includes receiving at least one approval feedback data element for the annotation via a third UI, pertaining to a third-level tagger; and calculating the QA score of the annotation further based on the approval feedback data element.

In some embodiments, the input data element corresponds to a specific geographical region, and comprises a plurality of causeway data elements, and wherein each portion of the input data element corresponds to a sub-region of the geographical region, and includes a subset of the plurality of causeway data elements.

In some embodiments, said annotation includes an indication of at least one causeway data element as representing a multi-level causeway or a single-level causeway.

In some embodiments, the one or more predefined classes are selected from: a first class, representing presence of a multi-level causeway in the portion, and a second class, representing absence of a multi-level causeway in the portion.

In some embodiments, the at least one processor may be further configured to assign the one or more annotation sub-tasks and obtain respective annotated portions within an iterative process, comprising a sequence of at least two iterations.

In some embodiments, the at least one processor may be further configured to: receive at least one supplementary data element related to one or more portions of the input data element by at least one common characterizing feature; and perform the multi-leveled quality assurance (QA) procedure on the plurality of annotations, based on the at least one respective supplementary data element.

In some embodiments, the at least one processor may be further configured to perform the multi-leveled quality assurance (QA) procedure further by: for at least one annotation sub-task, receiving an annotation via a first user interface (UI), said first UI pertaining to a respective first-level tagger; receiving at least one supervisory feedback data element for the annotation via a second UI, pertaining to a second-level tagger; and calculating the QA score of the annotation based on the supervisory feedback data element.

In some embodiments, the at least one processor may be further configured to perform the multi-leveled quality assurance (QA) procedure further by: receiving at least one approval feedback data element for the annotation via a third UI, pertaining to a third-level tagger; and calculating the QA score of the annotation further based on the approval feedback data element.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a tagging system for machine learning purposes according to some embodiments;

FIG. 2 is a block diagram, depicting an interconnection of a tagging system with other machine learning aspects, according to some embodiments;

FIG. 3A is a block diagram, depicting a tagging system for machine learning purposes, according to some embodiments;

FIG. 3B is a sequence diagram, depicting operation mode processes of a tagging system for machine learning purposes, according to embodiments of FIG. 3A;

FIG. 4A is a block diagram, depicting a tagging system for machine learning purposes, according to alternative embodiments;

FIG. 4B is a sequence diagram, depicting operation mode processes of a tagging system for machine learning purposes, according to embodiments of FIG. 4A;

FIG. 5A is a block diagram, depicting a tagging system for machine learning purposes, according to yet another alternative embodiments;

FIG. 5B is a sequence diagram, depicting operation mode processes of a tagging system for machine learning purposes, according to embodiments of FIG. 5A;

FIG. 6 is a flow diagram, depicting a method of training a machine-learning (ML) model, according to some embodiments; and

FIG. 7 is a flow diagram, depicting a method of training a machine-learning (ML) model, according to another embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements, and letters “A”, “B”, “C” may be changed in accordance with the number of the respective figure.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

In some embodiments of the present invention, ML model may be an artificial neural network (ANN).

A neural network (NN) or an artificial neural network (ANN), e.g., a neural network implementing a machine learning (ML) or artificial intelligence (AI) function, may refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. A processor, e.g., CPUs or graphics processing units (GPUs), or a dedicated hardware device may perform the relevant calculations.

It should be obvious for the one ordinarily skilled in the art that various ML models can be implemented without departing from the essence of the present invention. It should also be understood, that in some embodiments ML model may be a single ML model or a set (ensemble) of ML models realizing as a whole the same function as a single one. Hence, in view of the scope of the present invention, the abovementioned variants should be considered equivalent.

It should also be understood that in the context of this description, the terms “tagging”, “labeling”, and “annotating”, as well as derived forms of these terms may be used interchangeably.

The following description of the claimed invention is provided in accordance with the abovementioned task of tagging geographical data, e.g., multi-level causeways (multi-level transportation routes, e.g., pedestrian and automobile bridges, interchanges, tunnels etc.) on satellite images corresponding to specific geographical regions. Accordingly, in some aspects, the following description is referred to training of ML model that would classify incoming samples of input data elements (e.g., satellite images corresponding to specific geographical region and fragments or portions thereof) according to one or more predefined classes (e.g., presence/absence of causeways, types of causeways, like “driveway over driveway”, “driveway over walkway”, “driveway over waterway” etc.)

The supervised and semi-supervised training of an ML model faces the following obstructions in practice. Commonly, such training requires creating a training dataset by manually tagging the input data elements, distinguishing them by various types. There are certain problems of tagging geographical data, such as a necessity of dividing huge satellite image into portions (subregions), as well as aspects of detecting and tagging of geographical elements having specific characteristics of interest (e.g., topography, traffic, vegetation, edifices, causeways etc.). Furthermore, when it comes to the data, like satellite images, it is hard to provide proper annotation, e.g., it is hard to identify multi-level causeways, distinguish them from single-level crossroads, determine their type etc. This aspect can be crucial since errors in training dataset will dramatically decrease reliability of classification outputs provided by trained ML model.

In order to overcome this problem, a multi-level tagging approach is provided by embodiments of the invention, as described herein.

This specific embodiment is provided in order for the description to be sufficiently illustrative and it is not intended to limit the scope of protection claimed by the invention.

It should be understood for the one ordinarily skilled in the art that the implementation of the claimed invention in accordance with this task is provided as a non-exclusive example and other practical implementations can be covered by the claimed invention.

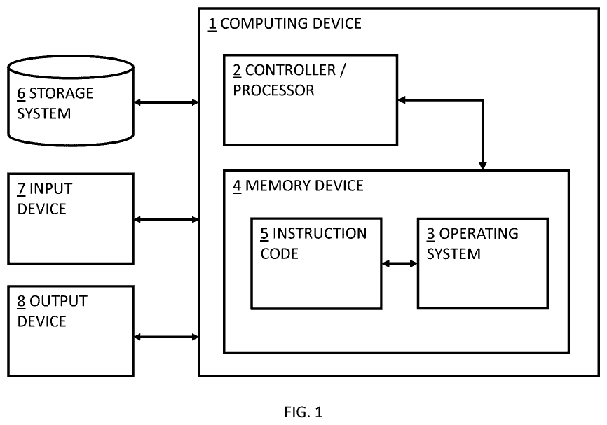

Reference is now made to FIG. 1, which is a block diagram, depicting a computing device which may be included in a tagging system for machine learning purposes according to some embodiments.

Computing device 1 may include a processor or controller 2 that may be, for example, a central processing unit (CPU) processor, a chip or any suitable computing or computational device, an operating system 3, a memory device 4, instruction code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to instruction code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory device 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long-term memory unit, or other suitable memory units or storage units. Memory device 4 may be or may include a plurality of possibly different memory units. Memory device 4 may be a computer or processor non-transitory readable medium, or a computer non-transitory storage medium, e.g., a RAM. In one embodiment, a non-transitory storage medium such as memory device 4, a hard disk drive, another storage device, etc. may store instructions or code which when executed by a processor may cause the processor to carry out methods as described herein.

Instruction code 5 may be any executable code, e.g., an application, a program, a process, task, or script. Instruction code 5 may be executed by processor or controller 2 possibly under control of operating system 3. For example, instruction code 5 may be an application that may provide tools for manual data tagging or be configured to realize automated or semi-automated data tagging, as well as be configured to train ML model, as it is further described herein. Although, for the sake of clarity, a single item of instruction code 5 is shown in FIG. 1, a system according to some embodiments of the invention may include a plurality of modules of instruction code similar to instruction code 5 that may be loaded into memory device 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Various types of datasets may be stored in storage system 6 and may be loaded from storage system 6 into memory device 4 where they may be processed by processor or controller 2.

In some embodiments, some of the components shown in FIG. 1 may be omitted. For example, memory device 4 may be a non-volatile memory having the storage capacity of storage system 6. Accordingly, although shown as a separate component, storage system 6 may be embedded or included in memory device 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to computing device 1 as shown by blocks 7 and 8.

It should be apparent that storage system 6, input device 7 and output device 8 may have both built-in and external implementation with respect to the computing device 1.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

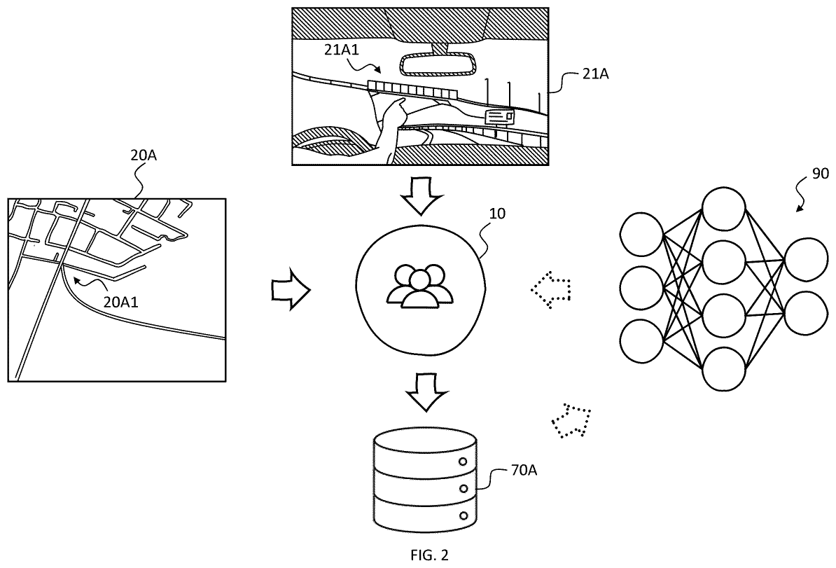

Reference is now made to FIG. 2, which is a block diagram, depicting an interconnection of a tagging system with other machine learning aspects, according to some embodiments.

As can be seen, tagging system (e.g., tagging system 10) represents an aspect of ML which is intrinsically integrated with other ML disciplines. In some embodiments, tagging system 10 may be configured to receive an input data element (e.g., an image from satellite images dataset 20A corresponding to specific geographical region and including a plurality of causeway data elements (e.g., causeway data element 20A1)). Tagging system 10 may be further configured to receive a supplementary data element (e.g., supplementary data element from supplementary dataset 21A), related to one or more portions of the input data element by some common characterizing feature (e.g., a photo of causeways related to respective portion of a satellite image by location (GPS) data). The supplementary data element may include causeway data element representing the same causeway as the input data element (e.g., causeway data element 21A1, representing the same causeway as causeway data element 20A1).

As can be seen, it is much easier to identify that the illustrated causeway is multi-leveled (driveway over driveway) based on the provided supplementary data element than based on the input data element. Consequently, it significantly decreases the chance of making mistakes during tagging of the correspondent portion of the input data element.

In some embodiments, tagging system 10 may output aggregated labeled satellite image dataset 70A as a result of tagging. Satellite image dataset 70A may be presented either in final or interim version.

Satellite image dataset 70A may further be utilized as supervisory data, to train the ML model (e.g., causeway classification ML model 90) so as to calculate a confidence value, representing confidence of pertinence of the one or more portions of the input data element (e.g., an image from satellite images dataset 20A) to the one or more predefined classes. The classes may include, for example, a first class, representing presence of a multi-level causeway in the portion of the input data element, and a second class, representing absence of a multi-level causeway in the portion.

It shall be understood that, in the context of the present invention, the term “confidence value” or “confidence score” refers to the well-known concept of ML-based classification practice. E.g., “confidence value” may represent a confidence of classification ML-based model outcome—that is, of pertinence of the input data element (or portions thereof) to the one or more predefined classes—in the form of values from 0 to 1, wherein “1” is a 100-percent confidence and “0” is, respectively, 0-percent confidence. It shall be appreciated by the person skilled in the art what “confidence value” represents and how it may be calculated.

Additionally, trained ML model 90 may be further inferred on the one or more non-annotated portions of the input data element, to calculate respective confidence values. These calculated confidence values may be further transferred as a feedback to system 10 to be used to support actions of tagging specialists (taggers) with respect to new incoming input data elements, as further described in detail herein.

As can be seen, the technical improvement of tagging may be provided based on the synergy of various ML aspects (e.g., supplementary data, feedback from trained ML model etc.).

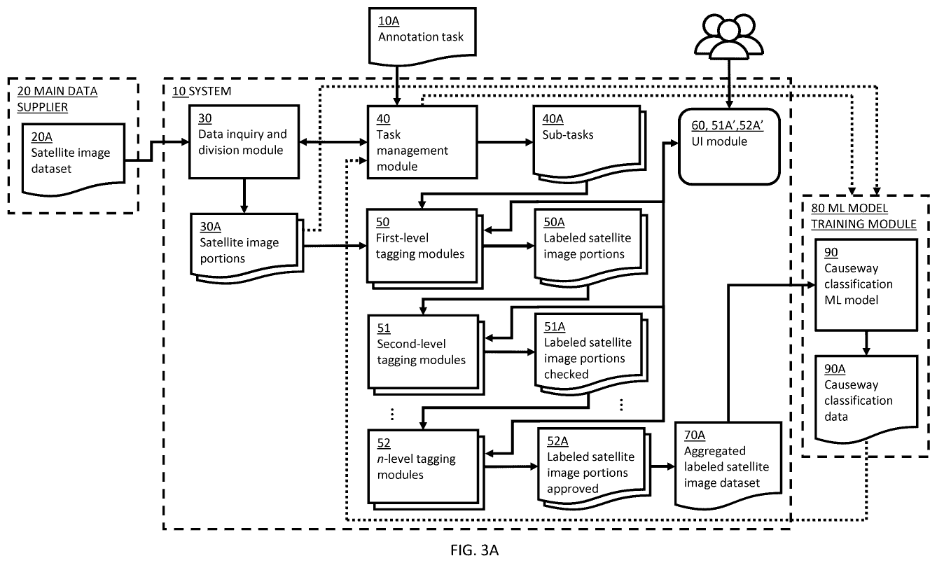

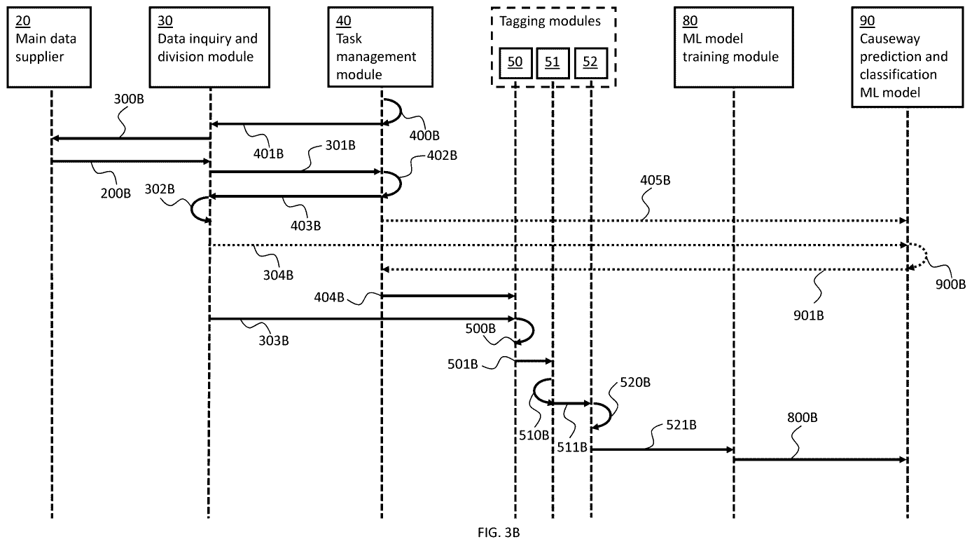

Reference is now made to FIG. 3A, which is a block diagram, depicting tagging system 10, and to FIG. 3B, which is a sequence diagram, depicting operation of system 10, according to some embodiments.

In general, the embodiment described with reference to FIGS. 3A and 3B is directed to system 10 which provides technical means for performing tagging with multi-leveled quality assurance (QA) procedure. In the illustrated embodiment, tagging and QA procedure are done by taggers manually via user interface (UI).

According to some embodiments of the invention, system 10 may be implemented as a software module, a hardware module, or any combination thereof. For example, system 10 may be or may include a computing device such as element 1 of FIG. 1. Furthermore, system 10 may be adapted to execute one or more modules of instruction code 5 to perform tagging of an input data element and provide further instructions for training causeway classification ML model 90 based on the labeled data to ML model training module 80. In some embodiments, an input data element may be an image from satellite images dataset 20A corresponding to specific geographical region.

Arrows may represent flow of one or more data elements to and from system 10 and/or among modules or elements of system 10. Some arrows may be omitted for the purpose of clarity.

In some embodiments, system 10 may be scalable and include variable number n of some modules, which can vary according to the specific purpose and task to which the specific embodiment is directed. For the sake of clarity, such elements are indicated using prefix “first-”, “second-” and “n-”, correspondently.

In some embodiments, system 10 may include data inquiry and division module 30, task management module 40, user interface (UI) module 60, first-level tagging module 50, second-level tagging module 51 and n-level tagging module 52.

In some embodiments, task management module 40 may be configured for receiving 400B of annotation task 10A representing a requirement for annotating an input data element. For example, the input data element is a one or more satellite image of satellite image dataset 20A stored in main data supplier 20 repository. In some embodiments, annotation task 10A may include a request to system 10 to indicate presence/absence of causeway data elements representing a multi-level causeway or a single-level causeway, types of causeway data elements, like “driveway over driveway”, “driveway over walkway”, “driveway over waterway” etc. Annotation task 10A may be provided by a user of system 10, for example, via network interface. Task management module 40 may be further configured to transfer, to data inquiry and division module 30, instruction 401B to generate request 300B to receive an input data element.

In some embodiments, data inquiry and division module 30 may be configured to generate request 300B to receive an input data element. In embodiments described herein, an input data element is a satellite image of satellite image dataset 20A. Data inquiry and division module 30 may be further configured to transfer request 300B to main data supplier 20. Data inquiry and division module 30 may be further configured to receive response 200B from main data supplier 20, wherein response 200B may include satellite images of satellite image dataset 20A, and transfer receipt confirmation 301B to task management module 40.

In some embodiments, task management module 40 may be further configured to perform division 402B of the annotation task 10A into a plurality of annotation sub-tasks 40A, each representing a requirement for annotating a respective non-annotated portion of the input data element. In some embodiments, each portion of the input data element (e.g., satellite image portion 30A) corresponds to a sub-region of the geographical region, which is illustrated on the input data element, and includes a subset of the plurality of causeway data elements.

Task management module 40 may be further configured to transfer instruction 403B to data inquiry and division module 30 to divide input data element (received satellite images of satellite image dataset 20A) into respective non-annotated portions (satellite image portions 30A), and data inquiry and division module 30 may be configured to perform division 302B of received satellite images into portions 30A according to instruction 403B.

In some embodiments, task management module 40 may be further configured to perform assigning 404B one or more annotation sub-tasks 40A of the plurality of sub-tasks 40A to one or more taggers via respective first-level tagging modules 50, and data inquiry and division module 30 may be configured to perform transmission 303B of satellite image portions 30A to first-level tagging modules 50 in accordance with assigned sub-tasks 40A.

In some embodiments, first-level tagging modules 50 may be configured to perform annotation 500B of satellite image portions 30A, e.g., perform indication of presence/absence of causeway data element, indication of causeway type, like “driveway over driveway”, “driveway over walkway”, “driveway over waterway” etc. In some embodiments, first-level tagging modules 50 may be configured to perform annotation 500B by means of UI module 60, which, in turn, may be configured to provide corresponding UI functionality to person who makes annotations-to first-level tagger. UI module 60 may be further configured to receive from first-level taggers a plurality of annotations 500B, corresponding to the assigned annotation sub-tasks 40A, via a first UI, said first UI pertaining to a respective first-level taggers. First-level tagging modules 50 may be configured to obtain respective annotated portions of the input data element (e.g., labeled satellite image portions 50A), based on a plurality of annotations 500B provided by first-level taggers corresponding to the assigned annotation sub-tasks 40A.

It should be understood, that in order to annotate significant amount of data by limited number of taggers, some actions that system 10 is configured to perform of, should be performed repeatedly (iteratively). Hence, in some embodiments, system 10 may be configured to perform some actions as an iterative process. Such actions may at least include assigning 404B one or more annotation sub-tasks 40A of the plurality of sub-tasks 40A to one or more taggers via respective first-level tagging modules 50 and obtaining respective annotated portions of the input data element (e.g., labeled satellite image portions 50A), based on a plurality of annotations 500B provided by first-level taggers corresponding to the assigned annotation sub-tasks 40A. The iterative process may include at least two iterations.

In some embodiments, assigning the one or more annotation sub-tasks and obtaining respective annotated portions are performed as an iterative process, comprising a sequence of at least two iterations. To be distinguished by the order of applying, iterations are herein called “initial”, “interim” and “final”.

In order to provide effective detection and correction of incorrectly tagged data and help tagging specialists to reduce the amount of tagging mistakes in future, in some embodiments, system 10 may be configured to perform a multi-leveled quality assurance (QA) procedure on the plurality of annotations 500B. The multi-leveled quality assurance (QA) procedure may be performed on at least one initial iteration of the iterative process. The multi-leveled QA procedure is performed by means of tagging modules 51 and 52, as further described herein.

In some embodiments, first-level tagging modules 50 may be configured to perform transmission 501B of labeled satellite image portions 50A to second-level tagging modules 51.

In some embodiments, second-level tagging modules 51 may be configured to perform supervision 510B of annotation 500B, e.g., perform indication on whether the annotation performed by first-level tagger is correct or incorrect. Second-level tagging modules 51 may be configured to perform supervision 510B by means of UI module 60, which, in turn, may be configured to provide corresponding user interface functionality to person who makes supervisions-to second-level tagger. In some embodiments, UI module 60 may be further configured to receive at least one supervisory feedback data element 51A′ for annotation 500B via a second UI, pertaining to respective second-level taggers. In some embodiments, second-level tagging modules 51 may be configured to produce checked labeled satellite image portions 51A as a result of annotation 500B and supervision 510B and to perform transmission 511B of checked labeled satellite image portions 51A to n-level tagging modules 52.

In some embodiments, n-level tagging modules 52 may include third-level tagging modules, which may be configured to perform approval 520B of annotation 500B and supervision 510B, e.g., perform indication on whether the annotation performed by first-level tagger is approved or not. In some embodiments, third-level tagging modules of n-level tagging modules 52 may be configured to perform approval 520B by means of UI module 60, which, in turn, may be configured to provide corresponding user interface functionality to person who makes approving-to third-level tagger. In some embodiments, UI module 60 may be further configured to receive at least one approval feedback data element 52A′ for annotation 500B via a third UI, pertaining to respective third-level taggers. In some embodiments, third-level tagging modules of n-level tagging modules 52 may be configured to produce approved labeled satellite image portions 52A as a result of annotation 500B, supervision 510B and approval 520B.

Additionally, in order to decrease the amount of tagging errors and thereby increase training dataset quality, the use of QA scoring of taggers'work is suggested. Therefore, in some embodiments, second-level tagging modules 51 may be configured to calculate a QA scores of annotations 500B based on supervisory feedback data elements 51A′ and to perform transmission of the QA scores to respective third-level tagging modules of n-level tagging modules 52. In some embodiments, third-level tagging modules of n-level tagging modules 52, in turn, may be configured to calculate the QA scores of annotations 500B further based on approval feedback data element 52A′. In some embodiments, third-level tagging modules may be further configured to perform transmission (not shown in figures) of plurality of QA scores to task management module 40.

E.g., in some embodiments, supervisory feedback data element 51A′, as well as approval feedback data element 52A′ may represent the value of the mistakenly or correctly completed sub-task with respect to its difficulty, which may be evaluated by second-level or n-level tagging modules 51 or 52 (e.g., by corresponding taggers), respectively, based on their own viewpoint on the sub-task difficulty, or based on the respectively calculated confidence value (as further described herein) of pertinence of the input data element portion, corresponding to the respective sub-task, to the at least one predefined class. Accordingly, the harder the correctly completed sub-task is, the more the calculated QA score may be increased, and respectively, the easier the incorrectly completed sub-task is, the more the calculated QA score may be decreased (as may be indicated by the respective supervisory data element and/or approval data element).

In some embodiments, task management module 40, in turn, may be further configured to perform assigning 404B one or more following annotation sub-tasks 40A of the plurality of sub-tasks 40A to one or more specific first-level tagging modules 50, based on the QA score. Assigning 404B may be performed on at least one interim or final iteration of the iterative process. Accordingly, in this way, annotation sub-tasks 40A may be assigned to specific first-level taggers which perform annotations 500B using the specific first-level tagging modules 50 via UI module 60, based on the QA score.

E.g., task management module 40, in turn, may be further configured to perform assigning 404B of one or more following annotation sub-tasks 40A in the following manner: annotation sub-tasks 40A that correspond to input data element portions with respect to which ML model 90 has calculated a low confidence value, e.g., less than 0.5 (calculation 900B, as described further below), may be assigned to first-level tagging modules with high QA score, as they may be considered more capable of performing “hard” tasks; while annotation sub-tasks 40A that correspond to input data element portions with respect to which ML model 90 has calculated a high confidence value, e.g., higher than 0.5 (calculation 900B, as described further below), may be assigned to first-level tagging modules with low QA score, as the classification is likely correct and such sub-tasks may be considered “easy”, hence, not requiring high quality and reliability of tagging.

In some embodiments, performance of the multi-leveled quality assurance (QA) procedure on the plurality of annotations, may be performed based on the calculated confidence value (calculation 900B, as described further below). E.g., sub-tasks corresponding to tagging input data element portions, that has been classified by ML model 90 with “high” confidence value (e.g., over 0.8), may be considered “easy” for tagging, and, accordingly, sub-tasks corresponding to tagging input data element portions, that has been classified by ML model 90 with “low” confidence value (e.g., below 0.8), may be considered “hard” for tagging. Accordingly, false performance of “easy” sub-tasks (presence of tagging mistakes) may be a signal for second-level tagging modules 51 (or n-level tagging modules 52) to calculate lower QA score for respective annotation 500B, than in cases with false performance of “hard” sub-tasks, that is to decrease the QA score less for mistakes in “easy” sub-tasks, than for mistakes in “hard” sub-tasks. This approach may also work respectively for successful performance of “easy” and “hard” sub-tasks.

The described multi-leveled QA procedure overall facilitates the process of data tagging and thereby increases training dataset quality and, consequently, increases reliability of ML model classification outputs.

In some embodiments, system 10 may be further configured to form the labeled dataset (e.g., labeled satellite image dataset 70A) by aggregating the annotated portions (e.g., satellite image portions 52A).

As it is described above, in practice, it is hard to define the specific amount of training data that is sufficient to achieve reliable training results. In order to overcome this problem, as well as in order to prioritize sub-tasks and provide sub-task assignment load balancing, the following solution is suggested.

In some embodiments, system 10 may be further configured to form, in at least one initial iteration, an interim version of the labeled dataset (e.g., labeled satellite image dataset 70A) by aggregating the annotated portions (e.g., satellite image portions 52A).

In some embodiments, third-level tagging modules of n-level tagging modules 52 may be further configured to perform transmission 521B of aggregated labeled satellite image dataset 70A to ML model training module 80. In some embodiments, ML model training module 80 may be further configured to perform, in at least one initial iteration, supervised or semi-supervised training 800B of the ML model (e.g., causeway classification ML model 90), by utilizing an interim version of the labeled dataset (e.g., labeled satellite image dataset 70A), so as to calculate a confidence value. The confidence value may represent confidence of pertinence of the one or more portions of the input data element (satellite image) to the one or more predefined classes. The predefined classes may include a first class, representing presence of a multi-level causeway in the portion, and a second class, representing absence of a multi-level causeway in the portion. In some embodiments, predefined classes may additionally include, e.g., types of multi-level causeways, like “driveway over driveway”, “driveway over walkway”, “driveway over waterway” etc.

In some embodiments, task management module 40 may be further configured to transmit, to the trained ML model (e.g., causeway classification ML model 90), instructions 405B to infer causeway classification ML model 90 on the one or more non-annotated portions of the input data element (e.g., satellite image portions 30A), in at least one interim iteration. Data inquiry and division module 30 may be further configured to perform transmission 304B of satellite image portions 30A to causeway classification ML model 90. In some embodiments, causeway classification ML model 90 may be further configured to perform calculation 900B of confidence values of pertinence of the one or more portions of the input data element (e.g., satellite image portions 30A) to the one or more predefined classes (e.g., presence/absence of multi-level causeways, types of multi-level causeways, like “driveway over driveway”, “driveway over walkway”, “driveway over waterway” etc.).

In some embodiments, causeway classification ML model 90 may be further configured to produce, in at least one interim iteration, causeway classification data 90A including results of calculation 900B. Causeway classification ML model 90 may be further configured to perform transmission 901B of causeway classification data 90A to task management module 40. In some embodiments, task management module 40 may be further configured to perform, in at least one interim iteration, assigning 404B of at least one annotation sub-task of the plurality of sub-tasks 40A to at least one first-level tagging module 50, based on the calculated confidence value.

In some embodiments, task management module 40 may be configured to have instructions, according to which, if additional positive annotations are needed based on causeway classification data 90A, task management module 40 performs, in at least one interim iteration, assigning 404B of annotation sub-tasks 40A according to the input data element portions with high confidence value of positive classification output. In some embodiments, task management module 40 may be configured to have instructions, according to which, if additional negative annotations are needed based on causeway classification data 90A, task management module 40 performs, in at least one interim iteration, assigning 404B of annotation sub-tasks 40A according to the input data element portions with low confidence value of positive classification output.

Furthermore, in some embodiments, task management module 40 may be configured to have instructions, according to which, task management module 40 performs, in at least one interim iteration, assigning 404B of annotation sub-tasks 40A with respect to the input data element portions with low confidence value of positive and/or negative classification output, in order to concentrate the tagging process, as well as subsequent learning process, on that type of input data element portions that ML model 90 cannot reliably and confidently classify, thereby improving training process efficiency.

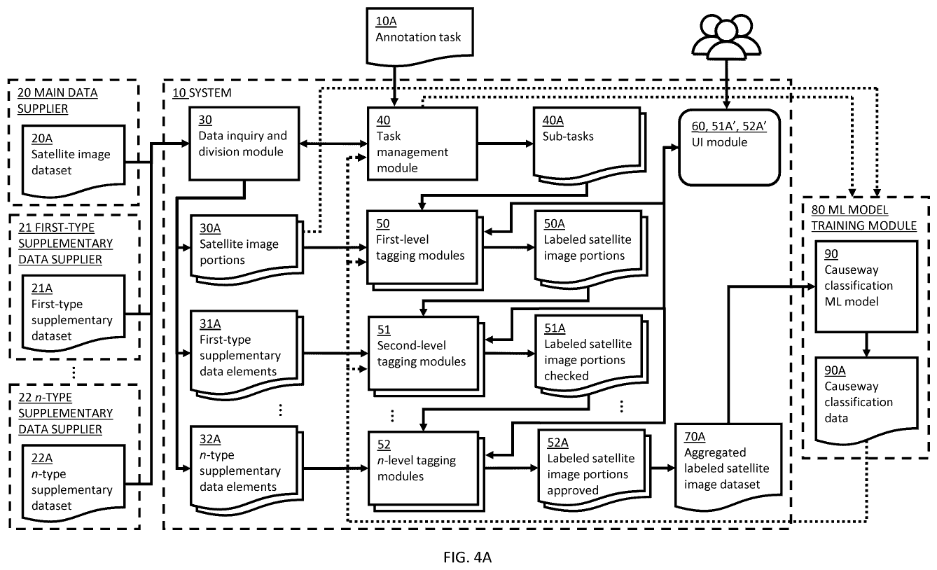

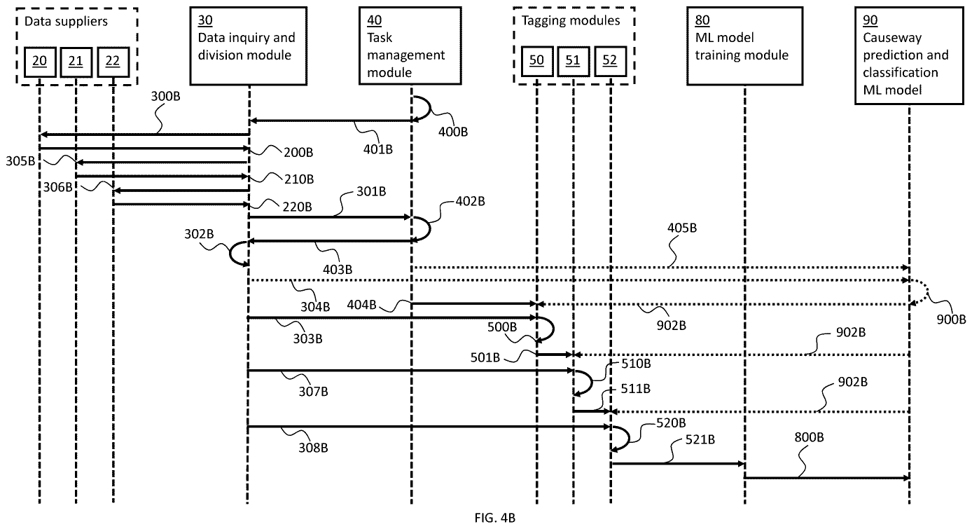

Reference is now made to FIG. 4A, which is a block diagram, depicting tagging system 10, and to FIG. 4B, which is a sequence diagram, depicting operation of system 10, according to alternative embodiments.

Embodiments represented in FIGS. 4A and 4B are similar in general aspects to embodiments represented in FIGS. 3A and 3B respectively, except for the further described aspects.

Embodiments represented in FIGS. 4A and 4B provide an additional way of decreasing the amount of tagging errors caused by the type of the input data. As described with reference to FIG. 2 above, there can be sets of supplementary data of another, more detailed, type available, which are interconnected with data of the main dataset, and which are easier to annotate. For example, there can be datasets of photos and videos related to one or more portions of the input data element (e.g., satellite images) by at least one common characterizing feature (e.g., by GPS coordinates). Obviously, it is much easier to identify the causeway object on such a supplementary data.

Hence, the idea of this aspect of the claimed invention is to develop a method of creating a labeled dataset for training a ML model to classify incoming samples of input data of less detailed type, wherein the method would involve data tagging supervision based on data of more detailed type.

In some embodiments, task management module 40 may be further configured to transfer, to data inquiry and division module 30, instruction 401B to generate request 300B to receive an input data element (e.g., satellite images of satellite image dataset 20A), supplementary data elements of first-type supplementary dataset 21A (e.g., photos of causeways with corresponding location data) and supplementary data elements of n-type supplementary dataset (e.g., video recordings from dashcams with corresponding location data). Data inquiry and division module 30 may be configured to generate request 305B to receive supplementary data elements of first-type supplementary dataset 21A, and transfer request 305B to first-type supplementary data supplier 21. Data inquiry and division module 30 may be configured to generate request 306B to receive supplementary data elements of n-type supplementary dataset 22A, and transfer request 306B to n-type supplementary data supplier 22. Data inquiry and division module 30 may be further configured to receive response 210B from first-type supplementary data supplier 21, wherein response 210B may include first-type supplementary data elements (photos of causeways with corresponding location data) of first-type supplementary dataset 21A, related to corresponding portions of the input data element (e.g., satellite images of satellite image dataset 20A) by at least one common characterizing feature (e.g., location data). In some embodiments, data inquiry and division module 30 may be further configured to receive response 220B from n-type supplementary data supplier 22, wherein response 220B may include n-type supplementary data elements (video recordings from dashcams with corresponding location data) of n-type supplementary dataset 22A, related to corresponding portions of the input data element (e.g., satellite images of satellite image dataset 20A) by at least one common characterizing feature (e.g., location data). In some embodiments, data inquiry and division module 30 may be further configured to transfer receipt confirmation 301B to task management module 40.

In some embodiments, data inquiry and division module 30 may be further configured to perform transmission 307B of first-type supplementary data elements 31A (e.g., photos of causeways with corresponding location data) to second-level tagging modules 51 in accordance with assigned sub-tasks 40A.

In some embodiments, system 10 is further configured to perform the multi-leveled quality assurance (QA) procedure on the plurality of annotations 500B, based on the at least one respective supplementary data element (e.g., first-type supplementary data elements 31A and n-type supplementary data elements 32A).

In particular, second-level tagging modules 51 may be configured to perform supervision 510B of annotation 500B, e.g., perform indication on whether the annotation performed by first-level tagger is correct or incorrect, by using first-type supplementary data elements 31A (photos of causeways with corresponding location data). In some embodiments, second-level tagging modules 51 may be configured to perform supervision 510B by means of UI module 60, which, in turn, may be configured to provide corresponding user interface functionality, including presenting of first-type supplementary data elements 31A, to person who makes supervisions-to second-level tagger. In some embodiments, UI module 60 may be further configured to receive at least one supervisory feedback data element 51A′ for annotation 500B via a second UI based on first-type supplementary data elements 31A, pertaining to respective second-level taggers.

In some embodiments, data inquiry and division module 30 may be further configured to perform transmission 308B of n-type supplementary data elements 32A (video recordings from dashcams with corresponding location data) to n-level tagging modules 52 in accordance with assigned sub-tasks 40A.

In some embodiments, n-level tagging modules 52 may include third-level tagging modules, which may be configured to perform approval 520B of annotation 500B and supervision 510B, e.g., perform indication on whether the annotation performed by first-level tagger is approved or not by using n-type supplementary data elements 32A (video recordings from dashcams with corresponding location data). In some embodiments, third-level tagging modules of n-level tagging modules 52 may be configured to perform approval 520B by means of UI module 60, which, in turn, may be configured to provide correspondent user interface functionality, including presenting of n-type supplementary data elements 32A, to person who makes approving-to third-level tagger. In some embodiments, UI module 60 may be further configured to receive at least one approval feedback data element 52A′ for annotation 500B via a third UI based on n-type supplementary data elements 32A, pertaining to respective third-level taggers.

Another difference between embodiments of FIGS. 4A and 4B comparing to embodiments of FIGS. 3A and 3B is in that, in at least one interim iteration, system 10 may be configured to perform the multi-leveled quality assurance (QA) procedure on the plurality of annotations 500B, based on the confidence values, calculated by causeway classification ML model 90 in result of inferring on the one or more respective portions of the input data element (e.g., satellite image portions 30A).

In particular, causeway classification ML model 90 may be further configured to perform transmission 902B of causeway classification data 90A to first-level tagging modules 50, and/or second-level tagging modules 51, and/or n-level tagging modules 52, to be presented to respective taggers via UI module 60. In such embodiments, system 10 thus provides additional supplemental information to taggers, supporting them in performing annotation 500B, supervision 510B and approval 520B respectively.

In some alternative embodiments, system 10 may be configured to substitute first-level tagging modules 50 by causeway classification ML model 90 and to substitute labeled satellite image portions 50A by causeway classification data 90A once causeway classification ML model 90 reaches predetermined confidence value threshold of classification outputs.

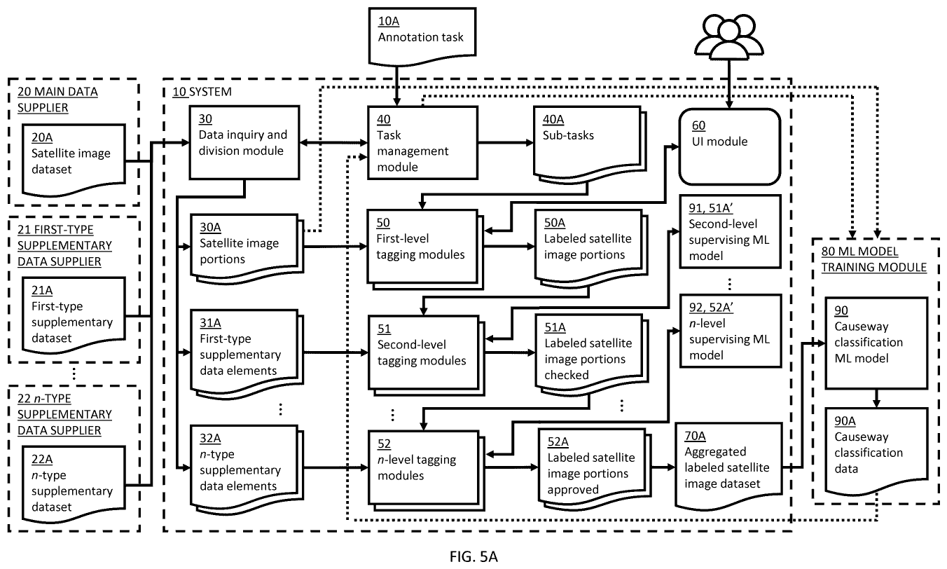

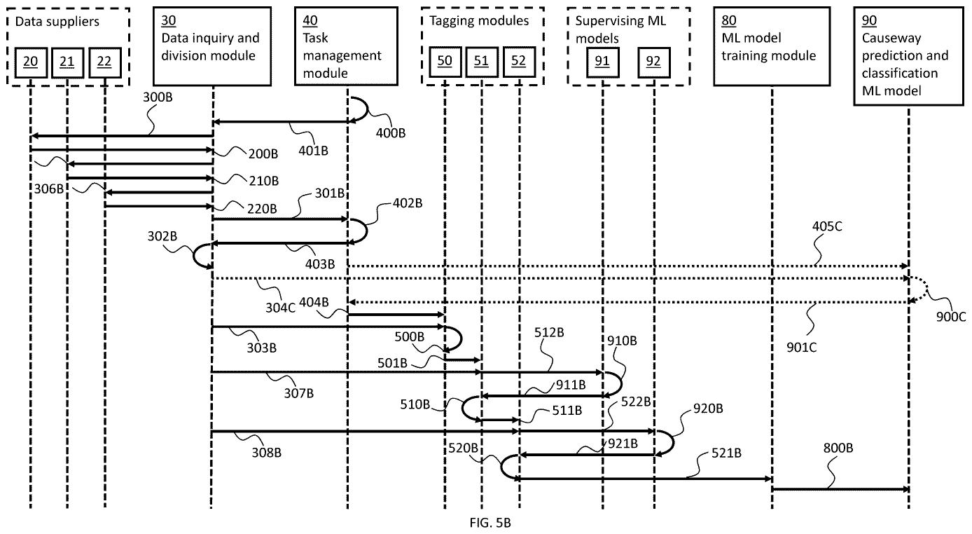

Reference is now made to FIG. 5A, which is a block diagram, depicting tagging system 10, and to FIG. 5B, which is a sequence diagram, depicting operation of system 10, according to alternative embodiments.

Embodiments represented in FIGS. 5A and 5B are similar in general aspects to embodiments represented in FIGS. 3A, 3B and 4A, 4B respectively, except for the further described aspects.

As further described herein, embodiments depicted in FIGS. 5A and 5B differ from embodiments depicted in FIGS. 3A, 3B and 4A, 4B in that the multi-leveled QA procedure (second-level tagging and n-level tagging) is performed in an automatic and not manual way. In illustrated embodiments, first-level tagging is still done manually (via UI module 60), hence, the entire tagging process is semi-automatic.

It should be understood to the one ordinarily skilled in the art that there may be embodiments including fully automated tagging process without departing from the essence of the present invention.

In some embodiments, system 10 further includes second-level supervising ML model 91 and n-level supervising ML model 92.

In some embodiments, second-level supervising ML model 91 may be configured to receive first-type supplementary data elements 31A (photos of causeways with corresponding location data) and to produce causeway classification output according to one or more predefined classes (e.g., presence/absence of causeways, types of causeways, like “driveway over driveway”, “driveway over walkway”, “driveway over waterway” etc.). In some embodiments, second-level supervising ML model 91 may be trained by supervised learning algorithms using a labeled set of training examples, which, in turn, may include pairs of photos of causeways with corresponding location data and indication of respective causeway presence/absence or causeway type. It should be apparent to the one skilled in the art that any ML model conventionally used for image recognition tasks could be used as second-level supervising ML model 91 without departing from the essence of the present invention.

In some embodiments, n-level supervising ML model 92 may be configured to receive n-type supplementary data elements 32A (video recordings from dashcams with corresponding location data) and to produce causeway classification output according to one or more predefined classes (e.g., presence/absence of causeways, types of causeways, like “driveway over driveway”, “driveway over walkway”, “driveway over waterway” etc.). In some embodiments, n-level supervising ML model 92 may be trained by supervised learning algorithms using a labeled set of training examples, which, in turn, may include pairs of video recordings from dashcams with corresponding location data and indication of respective causeway presence/absence or causeway type. It should be apparent to the one skilled in the art that any ML model conventionally used for image recognition tasks could be used as n-level supervising ML model 92 without departing from the essence of the present invention.

In some embodiments, second-level tagging modules 51 are configured to perform transmission 512B, to second-level supervising ML model 91, of first-type supplementary data elements 31A (photos of causeways with corresponding location data) and instructions of inferring 910B the second-level supervising ML model 91 on the received first-type supplementary data elements 31A. In some embodiments, second-level supervising ML model 91 may be configured to transmit response 911B including causeway classification output according to one or more predefined classes to second-level tagging modules 51.

In some embodiments, second-level tagging modules 51 may be configured to perform supervision 510B of annotation 500B, e.g., perform indication on whether the annotation performed by first-level tagger is correct or incorrect, by using causeway classification output received from second-level supervising ML model 91. In some embodiments supervision 510B may include comparing annotation 500B made by first-level tagger with class determined by second-level supervising ML model 91.

In some embodiments, n-level tagging modules 52 are configured to perform transmission 522B, to n-level supervising ML model 92, of n-type supplementary data elements 32A (video recordings from dashcams with corresponding location data) and instructions of inferring 920B the n-level supervising ML model 92 on the received n-type supplementary data elements 32A. In some embodiments, n-level supervising ML model 92 may be configured to transmit response 921B including causeway classification output according to one or more predefined classes to n-level tagging modules 52.

In some embodiments, n-level tagging modules 52 may be configured to perform approval 520B of annotation 500B and supervision 510B, e.g., perform indication on whether the annotation performed by first-level tagger is approved or not, by using causeway classification output received from n-level supervising ML model 92. In some embodiments approval 520B may include comparing annotation 500B made by first-level tagger with supervision 510B made by second-level tagging modules 51 and with class determined by n-level supervising ML model 92.

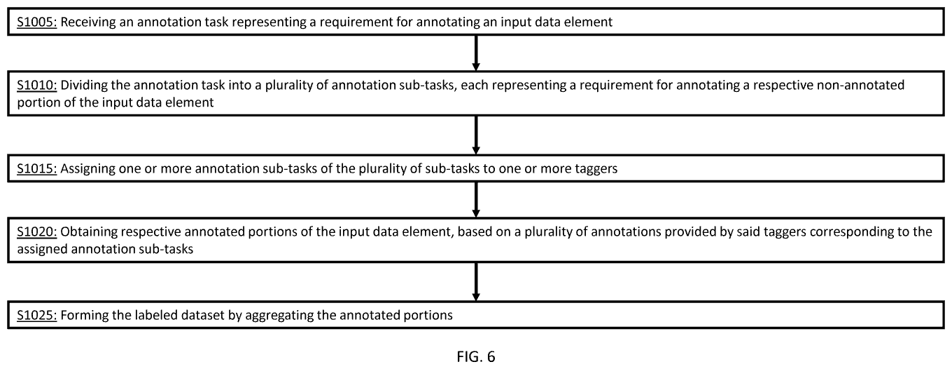

Referring now to FIG. 6, a flow diagram is presented, depicting a method of training a machine-learning (ML) model by at least one processor, according to some embodiments.

As shown in step S1005, the at least one processor (e.g., processor 2 of FIG. 1) may perform receiving 400B of annotation task 10A representing a requirement for annotating an input data element (satellite images of satellite image dataset 20A). Step S1005 may be carried out by task management module 40 and by data inquiry and division module 30 (as it is described with reference to FIGS. 3A, 3B, 4A, 4B, 5A, and 5B).

As shown in step S1010, the at least one processor (e.g., processor 2 of FIG. 1) may perform division 402B of the annotation task 10A into a plurality of annotation sub-tasks 40A, each representing a requirement for annotating a respective non-annotated portion of the input data element (respective satellite image portions 30A). Step S1010 may be carried out by task management module 40 (as it is described with reference to FIGS. 3A, 3B, 4A, 4B, 5A, and 5B).

As shown in step S1015, the at least one processor (e.g., processor 2 of FIG. 1) may perform assigning 404B of one or more annotation sub-tasks of the plurality of sub-tasks 40A to one or more taggers. Step S1015 may be carried out by task management module 40, first-level tagging modules 50 and UI module 60 (as it is described with reference to FIGS. 3A, 3B, 4A, 4B, 5A, and 5B).

As shown in step S1020, the at least one processor (e.g., processor 2 of FIG. 1) may obtain respective annotated portions of the input data element (e.g., labeled satellite image portions 50A), based on a plurality of annotations 500B provided by said taggers corresponding to the assigned annotation sub-tasks 40A. Step S1020 may be carried out by first-level tagging modules 50 and UI module 60 (as it is described with reference to FIGS. 3A, 3B, 4A, 4B, 5A, and 5B).

As shown in step S1025, the at least one processor (e.g., processor 2 of FIG. 1) may form the labeled dataset (e.g., aggregated labeled satellite image dataset 70A) by aggregating the annotated portions (e.g., labeled satellite image portions 50A). Step S1025 may be carried out by n-level tagging modules 52 (as it is described with reference to FIGS. 3A, 3B, 4A, 4B, 5A, and 5B).

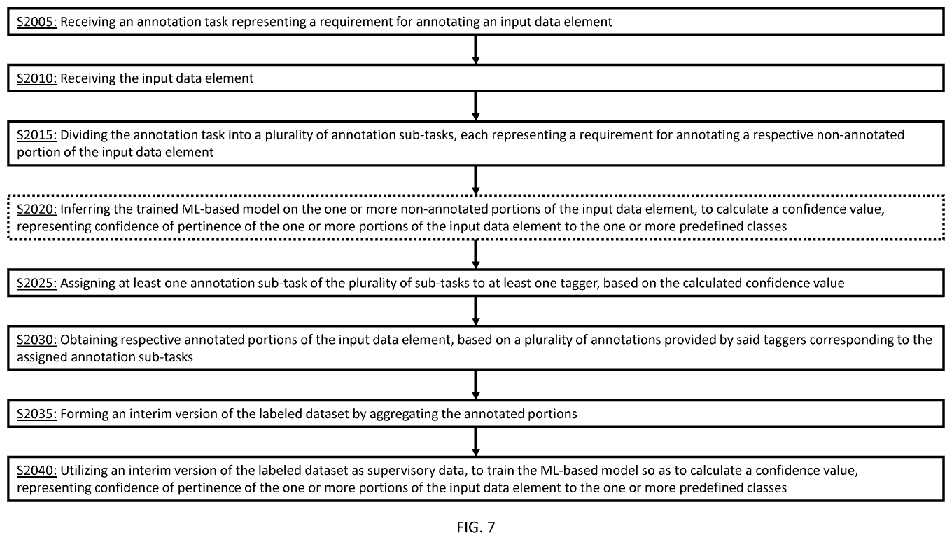

Referring now to FIG. 7, a flow diagram is presented, depicting a method of training a machine-learning (ML) model by at least one processor, according to another embodiments.

As shown in step S2005, the at least one processor (e.g., processor 2 of FIG. 1) may perform receiving 400B of annotation task 10A representing a requirement for annotating an input data element (e.g., satellite images of satellite image dataset 20A). Step S2005 may be carried out by task management module 40 and by data inquiry and division module 30 (as it is described with reference to FIGS. 3A, 3B, 4A, 4B, 5A, and 5B).

As shown in step S2010, the at least one processor (e.g., processor 2 of FIG. 1) may receive the input data element (e.g., satellite image of satellite image dataset 20A). Step S2010 may be carried out by data inquiry and division module 30 (as it is described with reference to FIGS. 3A, 3B, 4A, 4B, 5A, and 5B).

As shown in step S2015, the at least one processor (e.g., processor 2 of FIG. 1) may perform division 402B of the annotation task 10A into a plurality of annotation sub-tasks 40A, each representing a requirement for annotating a respective non-annotated portion of the input data element (e.g., respective satellite image portions 30A). Step S2015 may be carried out by task management module 40 (as it is described with reference to FIGS. 3A, 3B, 4A, 4B, 5A, and 5B).

As shown in step S2020, the at least one processor (e.g., processor 2 of FIG. 1) may infer the trained ML model (e.g., causeway classification ML model 90) on the one or more non-annotated portions of the input data element (e.g., satellite image portions 30A), to calculate a confidence value representing confidence of pertinence of the one or more portions of the input data element (e.g., satellite image portions 30A) to the one or more predefined classes (e.g., presence/absence of multi-level causeways, types of multi-level causeways, like “driveway over driveway”, “driveway over walkway”, “driveway over waterway” etc.). Step S2020 may be carried out by task management module 40 and ML model training module 80 (as it is described with reference to FIGS. 3A, 3B, 4A, 4B, 5A, and 5B).

As shown in step S2025, the at least one processor (e.g., processor 2 of FIG. 1) may perform assigning 404B of at least one annotation sub-task of the plurality of sub-tasks 40A to at least one tagger, based on the calculated confidence value. Step S2025 may be carried out by task management module 40, first-level tagging modules 50 and UI module 60 (as it is described with reference to FIGS. 3A, 3B, 5A, and 5B).

As shown in step S2030, the at least one processor (e.g., processor 2 of FIG. 1) may obtain respective annotated portions of the input data element (e.g., labeled satellite image portions 50A), based on a plurality of annotations 500B provided by said taggers corresponding to the assigned annotation sub-tasks 40A. Step S2030 may be carried out by first-level tagging modules 50 and UI module 60 (as it is described with reference to FIGS. 3A, 3B, 4A, 4B, 5A, and 5B).

As shown in step S2035, the at least one processor (e.g., processor 2 of FIG. 1) may form an interim version of the labeled dataset (e.g., aggregated labeled satellite image dataset 70A) by aggregating the annotated portions (e.g., labeled satellite image portions 50A). Step S2035 may be carried out by n-level tagging modules 52 (as it is described with reference to FIGS. 3A, 3B, 4A, 4B, 5A, and 5B).

As shown in step S2040, the at least one processor (e.g., processor 2 of FIG. 1) may utilize the interim version of the labeled dataset as supervisory data, to perform training 800B the ML model (e.g., causeway classification ML model 90) so as to calculate a confidence value, representing confidence of pertinence of the one or more portions of the input data element (e.g., satellite image portions 30A) to the one or more predefined classes (e.g., presence/absence of multi-level causeways, types of multi-level causeways, like “driveway over driveway”, “driveway over walkway”, “driveway over waterway” etc.). Step S2040 may be carried out by ML model training module 80 (as it is described with reference to FIGS. 3A, 3B, 4A, 4B, 5A, and 5B).

As it can be seen, the invention in embodiments described with reference to FIG. 7 provide the following improved technical effect-it facilitates the definition of a specific amount of training data that is sufficient to achieve reliable training results. In such embodiments, the process of creating a labeled dataset for training a machine-learning (ML) model becomes intrinsically interconnected with the process of training itself, which helps to optimize both processes. According to such embodiments of the method, first, an interim version of the labeled dataset (aggregated labeled satellite image dataset 70A) is formed by means of manual tagging of some portions of input data element (e.g., satellite image portions 30A), and then ML model (causeway classification ML model 90) may be trained based on the interim version of the labeled dataset. At this stage, causeway classification ML model 90 may be mostly unconfident both in positive and negative classification outputs (e.g., presence/absence of multi-level causeways) since the amount of supervisory data is not sufficient yet. Next, the entire process may be iteratively repeated having new non-annotated portions of input data element (e.g., satellite image portions 30A) tagged in each iteration. In each iteration, the ML model is additionally trained based on respective updated interim version of the labeled dataset (aggregated labeled satellite image dataset 70A). Furthermore, in each iteration, the version of the ML model that was trained in the previous iteration may be used to be inferred on new non-annotated portions of input data element and produce respective causeway classification data 90A. These causeway classification data 90A may be further used by means of task management module 40 in order to define which type of causeway data elements are poorly or mistakenly classified by ML model. This definition may be done by assessing in which cases the ML model has the less confidence value. Hence, task management module 40 may perform assigning 404B of only those annotation sub-tasks, that represent a requirement for annotating a portion of the input data elements, for which the ML model showed low confidence value.

Consequently, this helps to concentrate the tagging process only on problematic portions, and do not apply manual tagging with respect to portions, for which the ML model has already developed sufficient value of confidence. Hence, with each iteration, the ML model becomes more and more confident about the reliability of its classification outputs, and, consequently, the amount of annotation sub-tasks 40A to be assigned by task management module 40 decreases. The entire process may be terminated once the ML model gains the required confidence value. Hence, the training dataset gains its optimal size and quality in order to train the ML model sufficiently.

As it can be seen from the provided description, the claimed invention represents a technical solution which provides effective detection and correction of incorrectly tagged data and helps tagging specialists to reduce the number of tagging mistakes. The invention represents method of facilitating data tagging for machine learning purposes and thereby increases training dataset quality and, consequently, increases reliability of ML model prediction or classification outputs.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of creating, by at least one processor, a labeled dataset for training a machine-learning (ML) model, the method comprising:
receiving an annotation task representing a requirement for annotating an input data element;
dividing the annotation task into a plurality of annotation sub-tasks, each representing a requirement for annotating a respective non-annotated portion of the input data element;
assigning one or more annotation sub-tasks of the plurality of sub-tasks to one or more taggers;
obtaining respective annotated portions of the input data element, based on a plurality of annotations provided by said taggers corresponding to the assigned annotation sub-tasks;
forming the labeled dataset by aggregating the annotated portions.

2. The method of claim 1, wherein said assigning the one or more annotation sub-tasks and obtaining respective annotated portions are performed as an iterative process, comprising a sequence of at least two iterations.

3. The method of claim 2, wherein the sequence of at least two iterations further comprises
at least one initial iteration, further comprising
forming an interim version of the labeled dataset by aggregating the annotated portions; and
utilizing the interim version of the labeled dataset as supervisory data, to train the ML model so as to calculate a confidence value, representing confidence of pertinence of
the one or more portions of the input data element to the one or more predefined classes; and
at least one interim iteration, further comprising
inferring the trained ML model on the one or more non-annotated portions of the input data element, to calculate respective confidence values; and
assigning at least one annotation sub-task of the plurality of sub-tasks to one or more tagging modules, based on the calculated confidence value.

4. The method of claim 2, wherein the sequence of at least two iterations further comprises
at least one initial iteration, further comprising
performing a multi-leveled quality assurance (QA) procedure on the plurality of annotations, to obtain a respective plurality of QA scores; and
at least one interim iteration, further comprising
assigning the one or more annotation sub-tasks of the plurality of sub-tasks to specific taggers, based on the QA score.

5. The method of claim 4, wherein
the at least one initial iteration further comprises
forming an interim version of the labeled dataset by aggregating the annotated portions; and
utilizing the interim version of the labeled dataset as supervisory data, to train the ML model so as to calculate a confidence value, representing confidence of pertinence of the one or more portions of the input data element to the one or more predefined classes; and
at least one interim iteration further comprises
inferring the trained ML model on the one or more non-annotated portions of the input data element, to calculate respective confidence values; and
performing the multi-leveled quality assurance (QA) procedure on the plurality of annotations, based on the calculated confidence value.

6. The method of claim 4, wherein the method further comprises:
receiving at least one supplementary data element related to one or more portions of the input data element by at least one common characterizing feature; and
performing the multi-leveled quality assurance (QA) procedure on the plurality of annotations, based on the at least one respective supplementary data element.

7. The method of claim 4, wherein performing a multi-levelled QA procedure comprises:
for at least one annotation sub-task, receiving an annotation via a first user interface (UI), said first UI pertaining to a respective first-level tagger;
receiving at least one supervisory feedback data element for the annotation via a second UI, pertaining to a second-level tagger; and
calculating the QA score of the annotation based on the supervisory feedback data element.

8. The method of claim 7, further comprising:
receiving at least one approval feedback data element for the annotation via a third UI, pertaining to a third-level tagger; and
calculating the QA score of the annotation further based on the approval feedback data element.

9. The method of claim 1, wherein the input data element corresponds to a specific geographical region, and comprises a plurality of causeway data elements, and wherein each portion of the input data element corresponds to a sub-region of the geographical region, and comprises a subset of the plurality of causeway data elements.

10. The method of claim 9, wherein said annotation comprises an indication of at least one causeway data element as representing a multi-level causeway or a single-level causeway.

11. The method of claim 9, wherein the one or more predefined classes are selected from: a first class, representing presence of a multi-level causeway in the portion, and a second class, representing absence of a multi-level causeway in the portion.

12. A method of creating, by at least one processor, a labeled dataset for training a machine-learning (ML) model, the method comprising:
receiving an annotation task representing a requirement for annotating an input data element;
receiving the input data element;
dividing the annotation task into a plurality of annotation sub-tasks, each representing a requirement for annotating a respective non-annotated portion of the input data element;
performing an iterative process, wherein each iteration comprises:
inferring a pretrained ML-based model on one or more non-annotated portions of the input data element, to calculate a confidence value, representing confidence of pertinence of the one or more non-annotated portions of the input data element to the one or more predefined classes;
assigning at least one annotation sub-task of the plurality of sub-tasks to at least one tagger, based on the calculated confidence value;
obtaining respective annotated portions of the input data element, based on a plurality of annotations provided by said at least one tagger corresponding to the assigned at least one annotation sub-task;
forming an interim version of the labeled dataset by aggregating the annotated portions;
utilizing the interim version of the labeled dataset as supervisory data, to supplementary train the pretrained ML-based model so as to recalculate the confidence value.

13. A system for creating a labeled dataset, the system comprising: a non-transitory memory device, wherein modules of instruction code are stored, and at least one processor associated with the memory device, and configured to execute the modules of instruction code, whereupon execution of said modules of instruction code, the at least one processor is configured to:
receive an annotation task representing a requirement for annotating an input data element;
divide the annotation task into a plurality of annotation sub-tasks, each representing a requirement for annotating a respective non-annotated portion of the input data element;
assign one or more annotation sub-tasks of the plurality of sub-tasks to one or more taggers;
obtain respective annotated portions of the input data element based on a plurality of annotations, provided by said taggers corresponding to the assigned annotation sub-tasks; and
form the labeled dataset by aggregating the annotated portions.

14. The system of claim 13, wherein the at least one processor is further configured to assign the one or more annotation sub-tasks and obtain respective annotated portions within an iterative process, comprising a sequence of at least two iterations.

15. The system of claim 14, wherein the sequence of at least two iterations further comprises:
at least one initial iteration, further comprising:
forming an interim version of the labeled dataset by aggregating the annotated portions; and
utilizing the interim version of the labeled dataset as supervisory data, to train the ML model so as to calculate a confidence value, representing confidence of pertinence of the one or more portions of the input data element to the one or more predefined classes; and
at least one interim iteration, further comprising:
inferring the trained ML model on the one or more non-annotated portions of the input data element, to calculate respective confidence values; and
assigning at least one annotation sub-task of the plurality of sub-tasks to one or more tagging modules, based on the calculated confidence value.

16. The system of claim 14, wherein the sequence of at least two iterations further comprises:
at least one initial iteration, further comprising
performing a multi-leveled quality assurance (QA) procedure on the plurality of annotations, to obtain a respective plurality of QA scores; and
at least one interim iteration, further comprising
assigning the one or more annotation sub-tasks of the plurality of sub-tasks to specific taggers, based on the QA score.

17. The system of claim 16, wherein
the at least one initial iteration further comprises:
forming an interim version of the labeled dataset by aggregating the annotated portions; and
utilizing the interim version of the labeled dataset as supervisory data, to train the ML model so as to calculate a confidence value, representing confidence of pertinence of the one or more portions of the input data element to the one or more predefined classes; and
at least one interim iteration further comprises:
inferring the trained ML model on the one or more non-annotated portions of the input data element, to calculate respective confidence values; and
performing the multi-leveled quality assurance (QA) procedure on the plurality of annotations, based on the calculated confidence value.

18. The system of claim 16, wherein the at least one processor is further configured to:
receive at least one supplementary data element related to one or more portions of the input data element by at least one common characterizing feature; and
perform the multi-leveled quality assurance (QA) procedure on the plurality of annotations, based on the at least one respective supplementary data element.

19. The system of claim 16, wherein the at least one processor is further configured to perform the multi-leveled quality assurance (QA) procedure further by:
for at least one annotation sub-task, receiving an annotation via a first user interface (UI), said first UI pertaining to a respective first-level tagger;
receiving at least one supervisory feedback data element for the annotation via a second UI, pertaining to a second-level tagger; and
calculating the QA score of the annotation based on the supervisory feedback data element.

20. (canceled)

21. The system of claim 13, wherein the input data element corresponds to a specific geographical region, and comprises a plurality of causeway data elements, and wherein each portion of the input data element corresponds to a sub-region of the geographical region, and comprises a subset of the plurality of causeway data elements;
wherein said annotation comprises an indication of at least one causeway data element as representing a multi-level causeway or a single-level causeway; and
wherein the one or more predefined classes are selected from: a first class, representing presence of a multi-level causeway in the portion, and a second class, representing absence of a multi-level causeway in the portion.

22-23. (canceled)
